(19) United States
(12) Patent Application Publication
(10) Pub. No.: US 2008/0106379 A1
(43) Pub. Date: May 8, 2008

(54) ANTENNA USING OPTICAL RECORDING MEDIA

(75) Inventor: Richard M. Haddock, Redwood City, CA (US)

Correspondence Address: SCHNECK & SCHNECK, P.O. BOX 2-E, SAN JOSE, CA, 95109-0005, US

(73) Assignee: LASERCARD CORPORATION, Mountain View, CA (US)

(21) Appl. No.: 11/934,652

(22) Filed: Nov. 2, 2007

Related U.S. Application Data
(60) Provisional application No. 60/864,364, filed on Nov. 3, 2006.

(51) Int. Cl. H04B 7/00

(52) U.S. Cl. 340/10.1; 29/600

(57) ABSTRACT

An RFID device, where the antenna of the device is made of an optical media material. This optical material may be used to store optical data in a number of different forms, including as holograms and as pits having comparatively greater or lesser reflectivity compared to surrounding media. Alternatively, the RFID device includes optical media stores a security feature used to authenticate the RFID device.

### CROSS-REFERENCE TO RELATED APPLICATION

This application claims priority from U.S. provisional application No. 60/864,364, filed Nov. 3, 2006.

### TECHNICAL FIELD

The invention relates to miniature antennas, particularly for radio frequency identification (RFID) chips.

### BACKGROUND

Optical media provides a convenient and inexpensive technology for storing data. LaserCard Corporation (Mountain View, Calif.), a world leader in the production of optical data cards, sells a credit card size device having a data storage area. Such devices may be used to store medical, financial, immigration, or other sensitive data.

Patents and patent applications owned by LaserCard Corporation relating to security of data and data cards include U.S. patent application Ser. No. 10/434,253 filed May 7, 2003 entitled METHOD OF MAKING SECURE PERSONAL DATA CARD; U.S. patent application Ser. No. 11/052,481 filed Feb. 4, 2005 entitled SECURE TRANSACTIONS WITH PASSIVE STORAGE MEDIA; U.S. Pat. No. 5,457,747 granted Oct. 10, 1995 entitled ANTI-FRAUD VERIFICATION SYSTEM USING A DATA CARD; U.S. Pat. No. 5,932,865 granted Aug. 3, 1999 entitled ANTI-COUNTERFEIT VALIDATION METHOD FOR ELECTRONIC CASH CARDS EMPLOYING AN OPTICAL MEMORY STRIPE; U.S. Pat. No. 5,992,891 granted Nov. 30, 1999 entitled TAMPER RESISTANT IDENTIFICATION; U.S. Pat. No. 6,199,761 granted Mar. 13, 2001 entitled VALIDATION METHOD FOR ELECTRONIC CASH CARDS AND DIGITAL IDENTITY CARDS UTILIZING OPTICAL DATA STORAGE; U.S. Pat. No. 6,871,278 granted Mar. 22, 2005 entitled SECURE TRANSACTIONS WITH PASSIVE STORAGE MEDIA, all of which are hereby expressly incorporated by reference herein.

A number of the readers, reader components, or related technology for LaserCard optical cards are disclosed in U.S. Pat. No. 4,835,376 granted May 30, 1989 entitled READ/WRITE SYSTEM FOR PERSONAL INFORMATION CARD; U.S. Pat. No. 4,864,630 granted Sep. 5, 1989 entitled METHOD AND APPARATUS FOR READING DATA PAGES ON A DATA SURFACE; U.S. Pat. No. 4,972,397 granted Nov. 20, 1990 entitled DITHERING OPTICAL DATA LOGGER; U.S. Pat. No. 5,029,125 granted Jul. 2, 1991 entitled METHOD OF READING AND WRITING FILES ON NONERASABLE STORAGE MEDIA; U.S. Pat. No. 5,089,693 granted Feb. 18, 1992 entitled READER/WRITER FOR FLEXIBLE DATA CARDS; U.S. Pat. No. 5,559,885 granted Sep. 24, 1996 entitled TWO STAGE READ-WRITE METHOD FOR TRANSACTION CARDS; U.S. Pat. No. 6,145,742 granted Nov. 14, 2000 entitled METHOD AND SYSTEM FOR LASER WRITING MICROSCOPIC DATA SPOTS ON CARDS AND LABELS READABLE WITH A CCD ARRAY; U.S. Pat. No. 6,550,676 granted Apr. 22, 2003 entitled HYBRID CARD CONTACT ACTUATOR SYSTEM AND METHOD, all of which are hereby expressly incorporated by reference herein.

Patents of LaserCard Corporation relating to memory cards include U.S. Pat. No. 4,814,594 granted Mar. 21, 1989 entitled UPDATABLE MICROGRAPHIC POCKET DATA CARD; U.S. Pat. No. 4,810,868 granted Mar. 7, 1989 entitled ERASABLE OPTICAL WALLET-SIZE DATA CARD; U.S. Pat. No. 4,957,580 granted Sep. 18, 1990 entitled METHOD FOR MAKING AN OPTICAL DATA CARD; U.S. Pat. No. 5,241,165 granted Aug. 31, 1993 entitled ERASABLE OPTICAL WALLET-SIZE DATA CARD; U.S. Pat. No. 5,047,619 granted Sep. 10, 1991 entitled HIGH DENSITY TRACK LAYOUT FOR STORAGE MEDIA; U.S. Pat. No. 4,999,278 granted Mar. 12, 1991 entitled TRANSMISSIVELY READ OPTICAL RECORDING MEDIUM; U.S. Pat. No. 5,421,619 granted Jun. 6, 1995 entitled LASER IMAGED IDENTIFICATION CARD; U.S. Pat. No. 5,412,727 granted May 2, 1995 entitled ANTI-FRAUD VOTER REGISTRATION AND VOTING SYSTEM USING A DATA CARD; U.S. Pat. No. 6,290,130 granted Sep. 18, 2001 entitled ANTI-COUNTERFEIT AUTHENTICATION METHOD FOR OPTICAL MEMORY CARDS AND HYBRID SMART CARDS; U.S. Pat. No. 6,834,798 granted Dec. 28, 2004 entitled METHOD FOR CREATING A FINGERPRINT IMAGE ON AN OPTICAL MEMORY CARD, all of which are hereby expressly incorporated by reference herein.

RF devices have increasingly been adopted to provide data communication for product identification or other uses. Unlike bar codes, RF devices can allow data communication without line of sight access to the RF device, which may make an RFID tag more secure. However, RFID tags are not secure, and can be duplicated by replication of the RFID signal from the card. It is an object of the invention to provide an RFID device that allows for alternative data storage.

### SUMMARY

The above and other objects have been achieved with an RFID device which, in one embodiment, the RFID antenna includes an optical media material. The optical media may store data such as a hologram, a diffraction pattern, pits of greater or lesser reflectivity, data tracks or a microimage. Alternatively the RFID device may simply include optical media to store a security feature allowing access to data provided by the RFID device. The optical media insures that data could only be derived by the card if the card was in the line of sight of a card reader.

Another alternative embodiment is a device include a substrate, and an RFID antenna makde more an optical material and positioned on the substrate. Such a device could then store optical data, including data required to access the data on the RFID device. Such a device could be an active or passive device.

### BRIEF DESCRIPTION OF THE DRAWINGS

FIG. 1 is a top perspective view of an optical card, which has an RFID antenna.

FIG. 2A is a microscope magnification illustration of a substrate surface.

FIG. 2B is a refracted image from a surface.

### DETAILED DESCRIPTION OF THE INVENTION

This application relates to miniature antennas with an exemplary embodiment used with an RFID chip.

Creation of RFID Antennas Using Optical Media

Antennas are electrically tuned wires that correspond to wavelengths of interest, usually associated with a connected transmitter or receiver. The present invention involves use of optical recording media for the creation of RFID antennas. At least a portion of the RFID antenna would be an optically recordable medium that is tuned to the associated transmitter or receiver. This could then be adapted for a number of different applications.

Optical media is defined as any material that can store data, and have the data read using light. This could be diffractive, reflective, polarizing, etc. The data density would be appropriate for antenna wire size. In one embodiment, data marks could be placed photolithographically or otherwise created (e.g., ablated) on the antenna itself. The smallest lines that can be made by photolithography are feature size, approximately 2.25 microns, lines. Data spots smaller than feature size are feasible using sidewall mask and other techniques, but if data marks are feature size, then the associated antenna wires must be larger than this feature size to accommodate data.

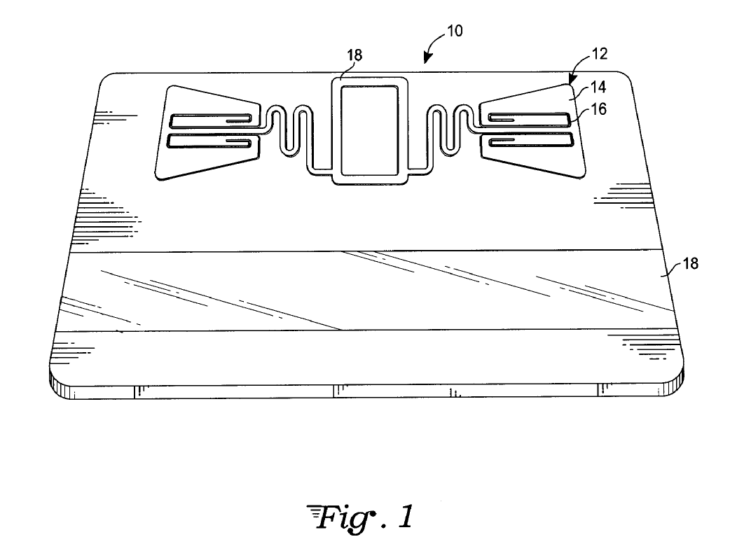

In another embodiment, data marks could be photolithographically or otherwise placed adjacent to the antenna, or in antenna interstices (such as location 16 in FIG. 1), or adjacent to the antenna. Still another embodiment is illustrated in FIG. 1, which shows a combined optical media storage device, (10) including a stripe of optical media (18) having a plurality of parallel tracks suitable for data recording onto said parallel tracks, combined with an antenna. This is similar to the 2.6 megabyte of data card sold by LaserCard Corporation, but with a printed antenna (12) to be connected to an RFID chip. As indicated, this antenna may be printed using the optical media, with printing producing a tuned element, i.e., antenna. The area of the antenna that is active is shown by traces 14, while the inactive area is shown by area 16. The optical media could be a portion of the actual antenna (element 14) or could be positioned in areas 16 which are not part of the antenna. Tuning requirements would be combined with data storage requirements.

Various patterns may be placed on the antenna area (14), as noted above. Using the phase-based media described above, tracks of laser ablated pits as well as a specified pattern may be included. As another embodiment, embossed metallized holograms may be printed onto the media and may even be included in the master plates that form the media. Pre-encoded data tracks may be formed in the hologram and can be used adjacent to an antenna. If the embossing is on dielectric material, such as plastic film, the optical pattern, hologram or otherwise, can be on a film layer placed over the antenna layer, which can be conductive traces printed on a lower level. The optical pattern need not be embossed on the film but may also be printed, or generated with alternate techniques.

In another embodiment, shown in cross-section in FIG. 3, the RF antenna is printed on an under layer (50), while the optical media is on an upper layer (40). A side section holds the integrated circuit (60). Both the upper layer and the lower layer may be inexpensive printed materials, combined to form a RFID tag or document.

A commercial radio frequency chip card, of the type having an antenna such as an RF transceiver chip on a substrate layer, is at a first generally planar level. A second layer of dielectric sheet material, not larger than the card of the first level overlies the chip card, and is adhered to the chip card, such as by lamination. The second layer could be stamped or printed with optical indicia. Information from the second layer is combined with information on the first layer to authenticate a user. Thus, even if the chip card is cloned, the clone would not have the second layer and could not be authenticated.

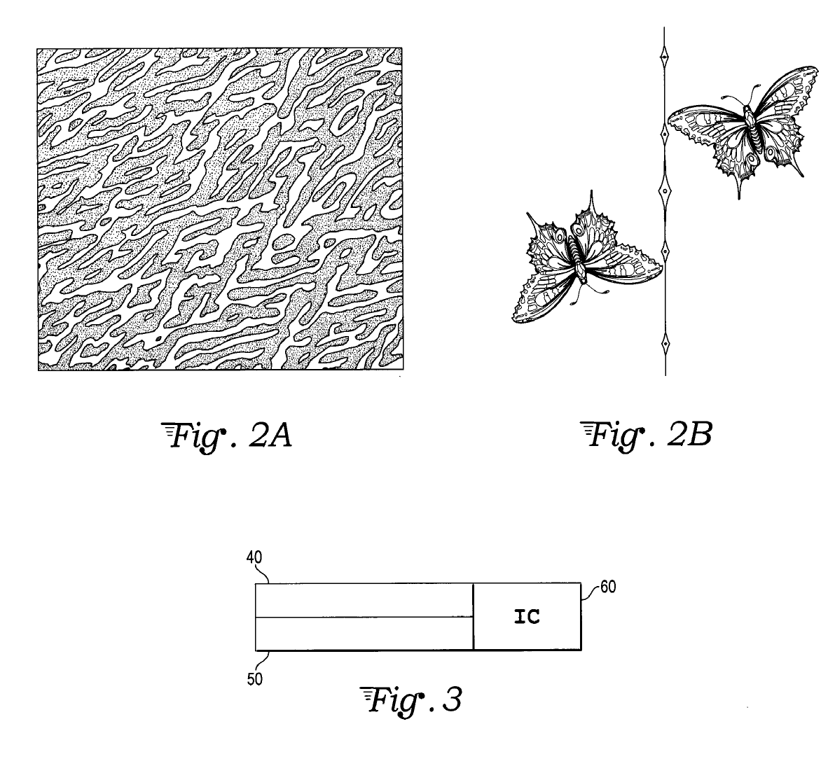

The optical media of the antenna, or alternatively, optical media on the other part of the card, may include a diffractive pattern. Such a diffractive pattern may also be used for security verification of the card. These patterns may be encoded with a roughly one micron pixel resolution. Such patterns look essentially random, as illustrated in FIG. 2A; however, when laser light is directed onto the diffractive pattern a picture is reflected from the optical media and is visible on a flat surface. FIG. 2B is a pattern generated by such a diffractive area.

Media

The media used by LaserCard utilizes a silver halide compound similar to that use in photographic applications. An alternate form of optically writeable and readable media can be used for data storage and is compatible with current LaserCard data storage technology. This media has two properties: first, it can be written and read such that it is adaptable to WORM applications. Second, the conductivity is adaptable for use as an RFID antenna. Such a combination has a number of benefits.

One example of such a media is an optical phase readout based media, similar to CDR or DVDR media, where three dimensional pre-encoded information is formed by techniques such as embossing, followed by sputter coating a WORM layer over the molded layer. The sputter coating is a metallic based material, which can be manufactured in two ways. In the first manufacturing method, a “Write Bright” media results, such that when writing with a laser to record information, the material is not melted but the crystalline structure is altered such that the pit becomes reflective. This would be read as one bit of information. Alternatively, in a second manufacturing method, a “Write Dark” media results from changing the thermal conductivity characteristics such that the laser melts the surface; melting the metallic surface away such that it is no longer reflective to the same degree, and the pits are less reflective. This may be preferred because it mimics the existing silver halide media that is also Write Dark. This would allow use of the new media using existing read/write, or read only instruments. The tracks could be formatted so that existing tracking components and software could be used.

The media in the above example is angstroms thick (e.g., 50-200 A), and the laser burns entirely through a pit data location to add data. Additionally, a number of different materials may be used.

In one embodiment, at least a KB of data would be stored on the antenna on the optical media storage area. In other embodiments the antenna could be made of more than one material.

As noted, the optical media may be a variety of different materials. These include an optically variable metal film. This would include a metal film capable of laser recording. This would include films having Write Once Read Many (WORM) properties.

In addition, a number of the possible media types are adaptable to higher density, including, but not limited to CD, DVD, or Blu Ray compatible optical media.

RFID

Radio frequency identification (RFID) is an automatic data transmission method. It relies on storing and remotely retrieving data using devices sometimes referred to as RFID tags or transponders. An RFID tag is an element that can be attached to an object and later powered to produce data. The RFID tags generally have two components: an antenna component and a silicon chip component. Passive tags require no internal power source, while active tags require a battery or other power source.

For passive RFID tags, a small electrical current is induced in the antenna by an incoming radio frequency signal. This radio frequency signal is from the RFID tag interrogation unit. The induced current provides sufficient power for the integrated circuit component to have enough power to transmit a response. This low power means that the device operates over a very short range. Thus, the antenna must be designed both to produce the power by an induced current, and to transmit the signal to an external read device. The information transmitted can be identification data, or the RFID tag may have a chip that can contain a non-volatile memory for storing additional data.

The lack of an integrated power supply means that these RFID devices can be quite small, making them adaptable for simple printing using commercial available RFID printers. Such tags may be made from silicon semiconductor, or non-silicon polymer semiconductors.

The alternative to passive RFID tags are active RFID tags, which have a power source. The active power source provides the ability to operate over a longer range, by transmitting at higher power levels, and accommodate in environments where transmission requires higher power.

An RFID system is designed to enable an RFID tag to be read by an RFID reader, providing data specific to the RFID tag. For example, on a passport an RFID tag may provide data specific to the user, namely biometric data such as height, eye color, weight, etc., passport number, immigration status, or other relevant document information. This information is stored in a memory chip connected to the antenna. When the tag is sufficiently proximate to an electromagnetic zone it will detect readers activation signal. For a passive tag, this signal is sufficient to induce power in the antenna, extract information from the chip, and transmit information back to the reader.

RFID passports are governed by standards that have been set by standard setting organizations such as the International Civil Aviation Organization (ICAO).

At least some of the optical media listed in the media section above have conductive properties. These vacuum coated media allow pre-encoded information to be stored on the media. The antenna may include parallel recorded/recordable data tracks. The auto track function of existing readers could be used to read RFID antenna tracks recorded if the RFID antenna is made of optical media.

Radio frequency identification technology has been developed by a number of companies, including Motorola/Indala (see U.S. Pat. Nos. 5,378,880 and 5,565,846), Texas Instruments (see U.S. Pat. Nos. 5,347,280 and 5,541,604), Mikron/Philips Semiconductors, Single Chip Systems (see U.S. Pat. Nos. 4,442,507; 4,796,074; 5,095,362; 5,296,722; and 5,407,851, CSIR (see European document numbers 0 494 114 A2; 0 585 132 A1; 0 598 624 A1; and 0 615 285 A2, IBM (see U.S. Pat. Nos. 5,528,222; 5,550,547; 5,521,601; and 5,682,143, and Sensormatic Elecytronics (see U.S. Pat. No. 5,625,341). All of these patents are hereby incorporated by reference, for all purposes herein. These tags all attempt to provide remote identification without the need for a battery. They operate at frequencies ranging from 125 KHz to 2.45 GHz. The lower frequency tags (˜125 KHz) are moderately resistant to shielding, but have only limited radio frequency functionality due to bandwidth constraints. In particular, systems based on these markers generally operate reliably only when a single tag is in the interrogation zone at a time. They also tend to be relatively bulky and expensive to manufacture. At high frequencies, (typically 13.56 MHz, 915 MHz, and 2.45 GHz), the added bandwidth available has permitted the development of systems which can reliably process multiple tags in the interrogation zone in a short period of time.

Holograms

One form of optical media are holograms. One possible implementation, using the media described in the above media section, is such that the molded media allows a variety of different patterns to be incorporated. Thus, pits of data to be burned into the media producing bits of data, or alternatively, patterns may be formed into the media. These three dimensional patterns may also store information. This would include embossed metallized holograms. These holograms may be formed simultaneously with pre-encoded data, thus in addition to pits, the holograms may be burned into the media. The optical media could include holograms, pre-encoded pits or burn pits, or any combination of these.

The inclusion of various patterns may allow optical data storage in 3-D. The different planes of the pattern would allow storage of information using not only a two-dimensional pattern, but allowing data storage at the various layers in the pattern as well. Holographic data storage may also allow for angle, or wavelength, or displacement, multiplexing for additional data storage density.

Security Features

By allowing the RFID antenna to be made of a material suitable for storing optical data, a range of different information may be stored. This would include the holder's biometric data (e.g., retina scan, fingerprint, etc).

One contemplated embodiment is to form optical media into the size of an IC chip. The media does not need to be a strip, but could be any known shape, while allowing recording. An IC chip optical media section may be a rectangle. Other known shapes could be also used.

For passive RFID, reading may be done at a variety of distances, as long as the distance is sufficiently small to allow induction of the antenna. In one embodiment, reading of the optical media is at 4 mm, as described in various prior patents incorporated by reference above.

The optical media may be shaped in two symmetric, or asymmetric, patterns joined at a point of contact with the IC chip.

Other Forms of the Media

The optical media, of which the antenna is made, may include a metallized holographic pattern. This pattern may be stamped, embossed or created in other manners.

As also noted, the pattern could have a diffractive pattern, to allow optical validation at a distance.

In another embodiment, the thin metallic pattern forming the optical media may contain a micro optical lens.

In another embodiment, the thin metallic pattern forming the optical media may contain retroreflective elements.

In another embodiment, the thin metallic pattern forming the optical media may contain microimaging of microimages, such as text, pictures or other unique shapes and patterns.

In another embodiment, the thin metallic pattern includes pictorial elements arranged in a specific manner, in order to optimize radiation characteristics required for powering the IC chip in contact with two distinctly different patterns.

What is claimed is:

1. A method comprising:
providing an RFID antenna for an RFID device which also includes optical media material; and
storing optical data on optical media material; and
using said optical data to provide a security feature from said RFID device.

2. The method of claim 1, wherein said optical data is derived from an optical means selected from the group consisting of a hologram, a diffraction pattern, a plurality of pits of greater or lesser reflectivity, a plurality of parallel data tracks, and a microimage.

3. The method of claim 1, further defined by making the antenna out of optical media material.

4. A method comprising:
manufacturing an RFID antenna of optical media material; and
storing optical data on said optical media material.

5. The method of claim 4, wherein said optical data is derived from an optical means selected from the group consisting of a hologram, a diffraction pattern, a plurality of pits of greater or lesser reflectivity, a plurality of parallel data tracks, and a microimage.

6. A method comprising:
providing an RFID antenna on a first layer of material; and
adding a second layer of optical recording material with data thereon over the first layer, the second layer having RF transmission compatibility with the first layer.

7. An RFID device comprising:
a substrate; and
an RFID antenna made from an optical media material on said substrate.

8. The device of claim 7, wherein said RFID device is an active device.

9. The device of claim 7, wherein said optical media material includes stored data.

10. The device of claim 7, wherein said optical media material includes a hologram.

11. The device of claim 7, wherein said optical media material includes tracks of pits in a reflective media.
